(19) United States
(12) Patent Application Publication
(10) Pub. No.: US 2026/0212345 A1
(43) Pub. Date: Jul. 23, 2026

(54) MULTIFACTOR AUTHENTICATION WITH PAYMENT CARDS

(71) Applicants: American Express Travel Related Services Company, Inc., New York, NY (US); American Express Service Europe Limited, London (GB)

(72) Inventors: Manik Biswas, Burgess Hill (GB); Ajay Babu Maddukuri, Phoenix, AZ (US); Mukund Shankar SimhaRaghu, Glendale, AZ (US)

(21) Appl. No.: 19/030,337

(22) Filed: Jan. 17, 2025

(51) Int. Cl. G06Q 20/38; G06Q 20/32

(52) U.S. Cl. CPC G06Q 20/3821; G06Q 20/3278

(57) ABSTRACT

Disclosed are various embodiments for multifactor authentication using payment cards. Transaction data associated with a transaction is received from a payment processing service. Then, a wireless connection is established with a payment card using the reader. Next, the transaction data is provided to the payment card. Subsequently, a cryptogram for the transaction is received from the payment card, the cryptogram being generated by the payment card using a cryptogram generating key stored on the payment card. Later, the cryptogram for the transaction is sent to the payment processing service.

### BACKGROUND

Users have a wide variety of options available for multi-factor authentication to authenticate themselves. For example, users may be able to enter a one-time password (OTP) that has been texted or emailed to them, or generated by an authentication application, in order to verify their identity or authenticate that a payment is authorized by the user (e.g., in a card-not-present transaction). As another example, users may be able to respond to a push notification that is sent to an authenticator application installed on their mobile device (e.g., smartphone or tablet) in order to verify their identity or authenticate that a payment is authorized by the user.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIGS. 1-3 are a drawing depicting one of several embodiments of the present disclosure.

FIG. 4 is a drawing of a network environment according to various embodiments of the present disclosure.

FIG. 5 is a sequence diagram illustrating one example of interactions between applications executed in in the network environment of FIG. 4 according to various embodiments of the present disclosure.

FIG. 6 is a sequence diagram illustrating one example of interactions between applications executed in in the network environment of FIG. 4 according to various embodiments of the present disclosure.

### DETAILED DESCRIPTION

Disclosed are various approaches for using a payment card, such as a debit card, credit card, or charge card, as a secondary form of authentication. Oftentimes, users will engage in transactions where their payment card is not physically present (or not required to be physically present). These transactions are often referred to as “card-not-present” (CNP) transactions. For example, a user could make a purchase over the phone, by mail-order catalogue, or online (e.g., with an electronic commerce merchant). To make these purchases, users often provide information such as their account number, billing address, name on the card, expiration date, card security code (CSC), card verification value (CVV), and potentially other information.

However, CNP transactions are often at a higher risk of fraud. For example, a fraudster could have copied or otherwise illicitly obtained the relevant information for a legitimate payment card. The fraudster could enter this information online or provide it over the phone to make a fraudulent purchase.

A variety of approaches are used to combat the risk of fraud in CNP transactions. For example, issuers often charge a higher rate to process CNP transactions to cover fraud losses. As another example, merchants or issuers will often require users to use multiple factors of authentication for high-value or high-risk transactions. For example, the issuer or the merchant could require that the user provide a one-time password sent by short message service (SMS) or email to a previously registered phone number or email address. One example of this approach is the 3D-Secure protocol.

However, multifactor authentication protocols have a number of weaknesses. For example, the phone number or email address could be out of date, such that the user fails to receive the one-time password. As another example, both SMS and email are unencrypted protocols, allowing for fraudsters to intercept and use a one-time password sent to a card holder. Moreover, SIM swapping, password cracking, phishing, and other forms of attacks allow fraudsters to take control of phone numbers or email accounts in order to receive and use one-time passwords sent to a card holder.

Various embodiments of the present disclosure solve these technical shortcomings of other multifactor authentication protocols for authenticating payments. In various embodiments of the present disclosure, after a user completes a CNP transaction, the user can be prompted to authenticate the transaction using his or her payment card that was used for the CNP transaction. The user can then place his or her payment card into proximity to a card reader (e.g., a near-field communication (NFC) reader included in smartphone, tablet, or similar device). The card reader can provide information about the transaction to the EUROPAY-MASTERCARD-VISA (EMV) chip installed on the payment card using the card reader. The EMV chip can generate a cryptogram to authenticate the transaction and return the cryptogram to the card reader, which can relay the cryptogram to the issuer of the payment card. This allows a card holder to prove that he or she is in physical possession of the payment card that was used for the CNP transaction and that he or she authorized the transaction. Because the physical payment card cannot be intercepted like a one-time password and because the EMV chip on the physical payment card cannot be readily cloned, the issuer can have greater confidence that the CNP transaction is legitimate. Effectively, the CNP transaction can be treated as if it were a card-present transaction for authorization purposes.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

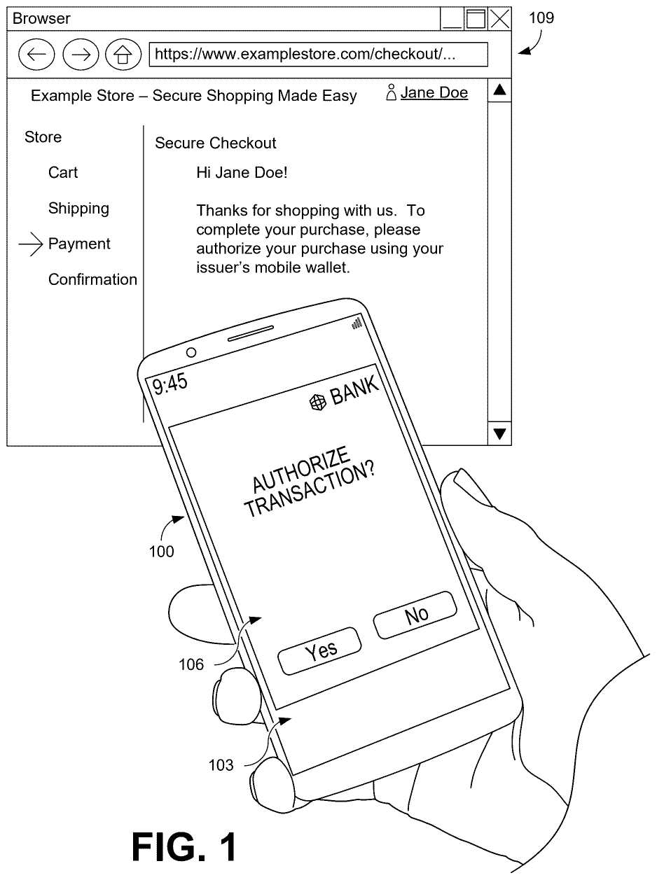

FIG. 1 depicts one example of a user experience according to various embodiments of the present disclosure. Here, a user holding a client device 100 (e.g., a smartphone or similar mobile device) to complete a transaction with an electronic commerce merchant by authorizing the transaction. Shown on the display 103 of the client device 100 is a user interface 106 with a prompt to the user to authorize the transaction. As illustrated, the transaction could have been made without a card being present (e.g., a card not present (CNP) transaction made with an online merchant or electronic commerce application or platform). As depicted, a browser interface 109 (e.g., executed by a user's desktop or laptop (not pictured)) could indicate at the end of the transaction that further authorization, verification, or authentication of the transaction is desired.

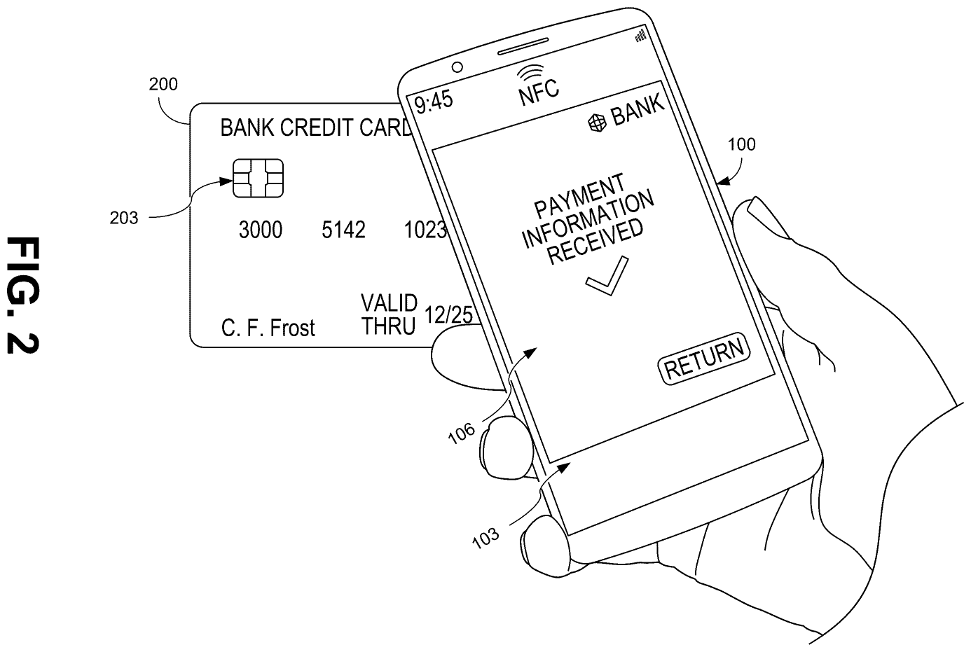

FIG. 2 depicts another example of the user experience according to various embodiments of the present disclosure. Here, in response to choosing to approve the transaction using the user interface 106 as depicted in FIG. 1, the user can bring his or her payment card 200 that was used for the card not present transaction in proximity to the client device 100. A reader on the client device can then interact with the EUROPAY-MASTERCARD-VISA (EMV) chip 203 of the payment card 200 to obtain a cryptogram authenticating the transaction. As a result, the user interface 106 shown on the display 103 of the client device 100 can provide an indication to the user that the payment information was received or obtained from the EMV chip 203 of the payment card 200.

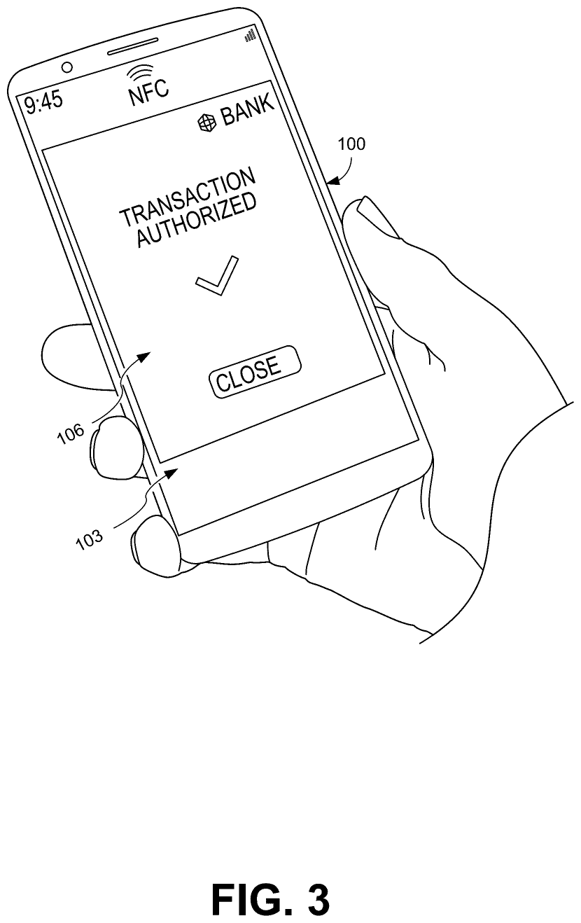

FIG. 3 depicts another example of the user experience according to various embodiments of the present disclosure. Here, after obtaining the cryptogram as depicted in FIG. 2, the cryptogram can then be sent to the issuer of the payment card 200 to show that the user was in possession of the card at the time of the CNP transaction. In response, the issuer can approve or authorize the transaction. The user interface 106 can present an indicator to the user on the display 103 of the client device 100 that the transaction has been authorized.

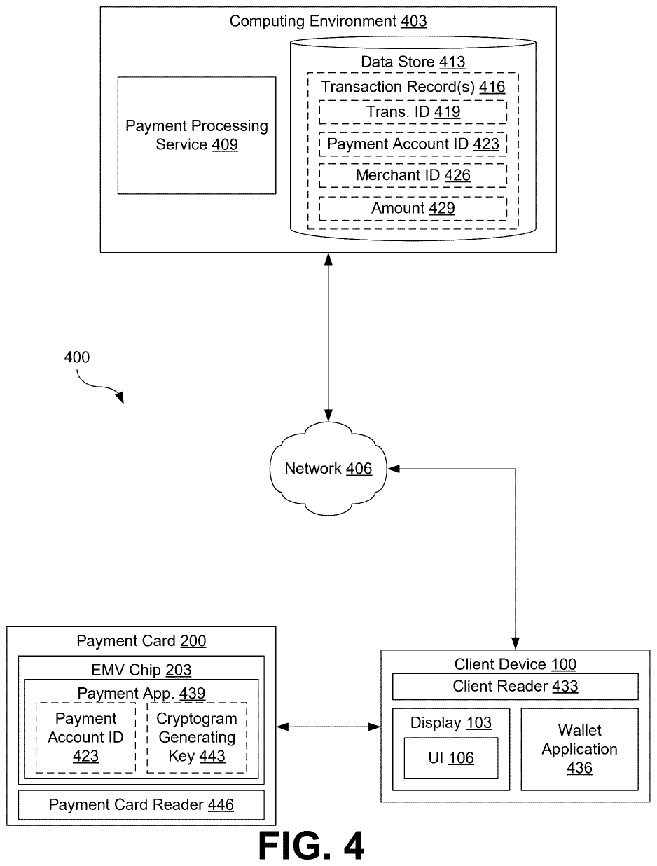

With reference to FIG. 4, shown is a network environment 400 according to various embodiments. The network environment 400 can include a computing environment 403, and a client device 100, which can be in data communication with each other via a network 406. Moreover, the client device 100 can be in direct communication with a payment card 200 (e.g., via a wireless connection between the client device 100 and the payment card 200).

The network 406 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 406 can also include a combination of two or more networks 406. Examples of networks 406 can include the Internet, intranets, extranets, virtual private networks (VPNs), and similar networks.

The computing environment 403 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 403 can employ a plurality of computing devices that can be arranged in one or more server banks or computer banks or other arrangements. Such computing devices can be located in a single installation or can be distributed among many different geographical locations. For example, the computing environment 403 can include a plurality of computing devices that together can include a hosted computing resource, a grid computing resource or any other distributed computing arrangement. In some cases, the computing environment 403 can correspond to an elastic computing resource where the allotted capacity of processing, network, storage, or other computing-related resources can vary over time.

Various applications or other functionality can be executed in the computing environment 403. The components executed on the computing environment 403 can include a payment processing service 409. The computing environment 403 can also execute other applications, services, processes, systems, engines, or functionality not discussed in detail herein.

Also, various data is stored in a data store 413 that is accessible to the computing environment 403. The data store 413 can be representative of a plurality of data stores 413, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 413 is associated with the operation of the various applications or functional entities described below. This data can include one or more transaction records 416 and potentially other data.

A transaction record 416 can represent an individual transaction made using a payment card 200. For example, a purchase made with a merchant using the payment card 200 could result in the payment processing service 409 creating and storing a respective transaction record 416 in the data store 413. Accordingly, a transaction record 416 can include information such as a transaction identifier 419, a payment account identifier 423, a merchant identifier 426, and/or an amount 429.

The transaction identifier 419 can be any identifier that uniquely identifies a transaction record 416 with respect to other transaction record 416. A transaction identifier 419 could be implemented using a sequential counter (e.g., 00001, 00002, 00003, 00004, etc.). A transaction identifier 419 could also be implemented as a cryptographic hash of transaction data, such as the payment account identifier 423, the merchant identifier 426, the amount 429, and/or the date and time of the transaction. A transaction identifier 419 could also be implemented as a tuple of values where the combination of values in the tuple can be expected to be unique, such as a combination of a sequential counter and a merchant identifier 426. Other approaches could also be used according to various embodiments of the present disclosure.

The payment account identifier 423 is any identifier that uniquely identifies a payment account with respect to another payment account. Examples of payment account identifiers 423 include unique account numbers assigned by financial institutions to individual payment accounts (e.g., demand deposit account number, credit card account number, debit card account number, charge card account number, etc.).

The merchant identifier 426 is any identifier that uniquely identifies a merchant with respect to another merchant. Merchant identifiers can include a merchant name, a merchant identification number (which can include any alphanumeric or numeric identifier), or other identifier suitable to the various embodiments of the present disclosure.

The amount 429 can represent the numeric value of the transaction and can be represented in any currency. The amount 429 could represent the total value of the transaction (e.g., inclusive of the price of the goods or services as well as applicable taxes, gratuities, surcharges, etc.). In some instances, the amount 429 can include both the total amount and any subtotal amounts.

The payment processing service 409 can be executed to handle payment transactions on behalf of a merchant. The payment processing service 409 accordingly can be configured to receive transaction authorization requests from a merchant, authorize or deny the transaction, and return the authorization response or decision back to the merchant.

The client device 100 is representative of a plurality of client devices that can be coupled to the network 406. The client device 100 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 100 can include one or more displays 103, such as liquid crystal displays (LCDs), gas plasma-based flat panel displays, organic light emitting diode (OLED) displays, electrophoretic ink (“E-ink”) displays, projectors, or other types of display devices. In some instances, the display 103 can be a component of the client device 100 or can be connected to the client device 100 through a wired or wireless connection.

The client device can also include a client reader 433, which can be configured to detect the presence of other devices capable of wireless communication and exchange data with these other devices. For example, the client reader 433 could be a near-field communication (NFC) reader that is capable of detecting other NFC-enabled devices (e.g., a payment card 200) and exchanging data with the NFC-enabled devices.

The client device 100 can be configured to execute various applications such as a wallet application 436 or other applications. The wallet application 436 can be executed by a client device 100 to store payment information related to one or more payment instruments, make payments using the stored payment instruments, and/or access information about a user account related to one or more of the stored payment instruments (e.g., accessing or reviewing transaction records 416 related to a payment account identifier 423 for a stored payment instrument). The wallet application 436 can also be executed to allow a user to authorize transactions made using a payment card 200, as further described herein. Accordingly, the wallet application 436 could cause a user interface 106 to be shown on the display 103 to provide information to a user or to obtain information or input from the user. The client device 100 can be configured to execute applications beyond the wallet application 436, such as email applications, social networking applications, word processors, spreadsheets, or other applications.

The payment card 200 can represent any physical card that represents a payment instrument identified by a respective payment account identifier 423. For example, a payment card 200 could be a debit card, credit card, or charge card linked to a respective debit card number, credit card number, or charge card number linked to a respective demand deposit account, or line of credit (e.g., a credit card or charge card account). As discussed, a payment card 200 can include a EUROPAY®, MASTERCARD®, and VISA® (EMV) chip 203.

The EMV chip 203 can be used to authenticate a transaction to prove that the payment card is an authorized or valid payment card and has neither expired nor been counterfeited. Accordingly, the EMV chip 203 can include a payment application 439. The payment application 439 could include information such as the payment account identifier 423 of the payment instrument that the payment card 200 represents. The payment application 439 could also include data such as a cryptogram generating key 443 or other data such as an application transaction counter (ATC). The payment application 439 can be executed to confirm or authorized transactions made using the payment card. For example, the payment application 439 could use at least the cryptogram generating key 443 to generate a cryptogram that proves that the user involved with a transaction (e.g., making a purchase) has possession of the payment card 200.

The payment card 200 could also include a payment card reader 446. The payment card reader 446 can include any device or mechanism that allows to communicate wirelessly with other devices. For example, the payment card reader 446 could be implemented as a loop antenna that is directly or inductively coupled to the EMV chip 203, thereby allowing the EMV chip 203 to be powered by and communicate with the client reader 433 when placed in proximity to the client reader 433 of the client device 100. In such situations, the payment card reader 446 could be configured to communicate using the near-field communication (NFC) protocol.

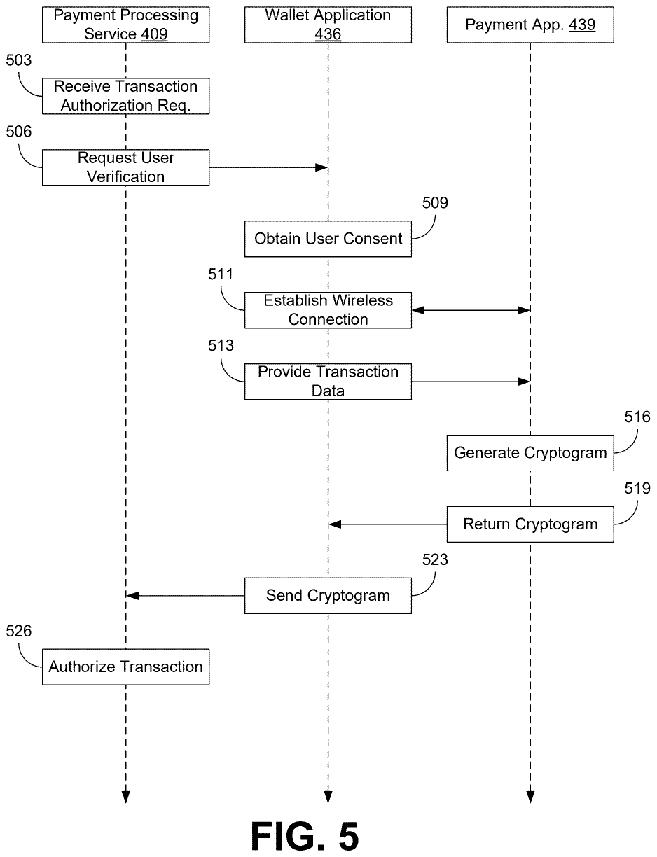

Referring next to FIG. 5, shown is a sequence diagram that provides one example of the operation of portions of the payment processing service 409, wallet application 436, and the payment application 439. The sequence diagram of FIG. 5 provides merely an example of the many different types of functional arrangements that can be employed to implement the operation of the depicted portions of the payment processing service 409, wallet application 436, and the payment application 439. As an alternative, the sequence diagram of FIG. 5 can be viewed as depicting an example of elements of a method implemented within the network environment 400.

Beginning with block 503, the payment processing service 409 can receive a transaction authorization request from a merchant. For example, a merchant's point-of-sale (PoS) system could obtain payment information from a user for a transaction. In a card-not-present (CNP) transaction, such as when a user makes a purchase with online (e.g., e-commerce) merchant, the merchant could obtain information such as the user's name, billing address, payment account identifier 423, payment account expiration date, and/or a card security code (CSC) or card verification value (CVV). This information could be included with a merchant identifier 426, amount 429, and/or transaction identifier 419. This transaction data could be included in a transaction authorization request sent to the payment processing service 409. The payment processing service 409 could then create a transaction record 416 and store the received information in the transaction record 416 for future reference.

In response, at block 506, the payment processing service 409 could send a verification request to the wallet application 436. The payment processing service 409 could select the correct instance of the wallet application 436 and/or client device 100 to send the verification request to by determining which wallet application 436 is associated with a user identifier (e.g., a username, email address, or other identifier that uniquely identifies a user with respect to another user) that is also associated with the payment account identifier 423 for the transaction authorization request. The verification request could, in some instances, include the merchant name or other merchant identifier 426 associated with the transaction, the amount 429 of the transaction, and the date/time of the transaction. This information could assist the user in determining whether he or she wishes to authorize, validate, or verify the transaction.

Accordingly, at block 506, the wallet application 436 can obtain the user's consent or intent to authorize the transaction. For example, the wallet application 436 can cause a user interface 106 to be shown on a display 103 of the client device 100. The user interface 106 could present information provided by the payment processing service 409, such as the merchant name or other merchant identifier 426 associated with the transaction, the amount 429 of the transaction, and the date/time of the transaction. The user interface 106 could also provide an ability for the user to indicate an intent to authorize the transaction or decline the transaction. The response of the user can then be returned to the payment processing service 409. If the user indicates that he or she wishes to validate the transaction, then the process can proceed to block 511.

However, if the user indicates that he or she does not wish to validate the transaction, then the wallet application 436 could return a message or indicator to that effect. The depicted process could then end. In some implementations, the transaction could be rejected. In other implementations, the payment processing service 409 could process the transaction authorization request according to various other criteria, which could result in approval or denial of the transaction authorization request.

Then, at block 511, the wallet application 436 of the client device 100 can establish a wireless connection with the payment application 439 of a payment card 200. For example, the user could place his or her payment card 200 in proximity to the client reader 433 of the client device 100, allowing the client device 100 and payment card 200 to establish a wireless connection (e.g., a near-field communication (NFC) connection).

At block 513, after the wireless connection has been established, the wallet application 436 can provide at least a portion of the transaction data sent at block 506 by the payment processing service 409 to the payment application 439. In some implementations, all of the transaction data could be provided to the payment application 439. In other implementations, only the portion of the transaction data necessary for the payment application to generate a cryptogram could be provided.

Proceeding to block 516, the payment application 439 can generate a cryptogram to reflect an authorization, approval, or verification of the transaction in response to receiving the transaction data from the wallet application 436. The cryptogram can be generated using the cryptogram generating key 443 and potentially other data (e.g., an application transaction counter (ATC)). Various algorithms can be used, such as cryptogram generating algorithms specified by various versions of the EUROPAY-MASTERCARD-VISA (EMV) standard or other publicly available cryptogram generating algorithms. For example, the payment application 439 could generate an Authorization Request Cryptogram (ARQC) or a Transaction Certificate (TC).

Then, at block 519, the payment application 439 can return the cryptogram at block 519 to the wallet application 436 using the wireless connection established at block 511.

Next, at block 523, the wallet application can send the cryptogram generated by the payment application 439 at block 516 and provided at block 519 back to the payment processing service 409.

Subsequently, at block 526, the payment processing service 409 can authorize the transaction associated with the transaction authorization request. The authorization can be based at least in part on the cryptogram, as well as other factors. For example, the payment processing service 409 could determine that the cryptogram is a valid cryptogram. This could be used to verify that the user has the physical payment card 200 in his or her possession to use to authenticate the transaction that was made with the merchant, effectively allowing a CNP transaction (such as an ecommerce transaction) to be treated as a card-present transaction for authorization purposes. In some implementations, the payment processing service 409 could generate an application response cryptogram (ARPC) and return it to the terminal of the merchant (e.g., via the acquirer of the merchant).

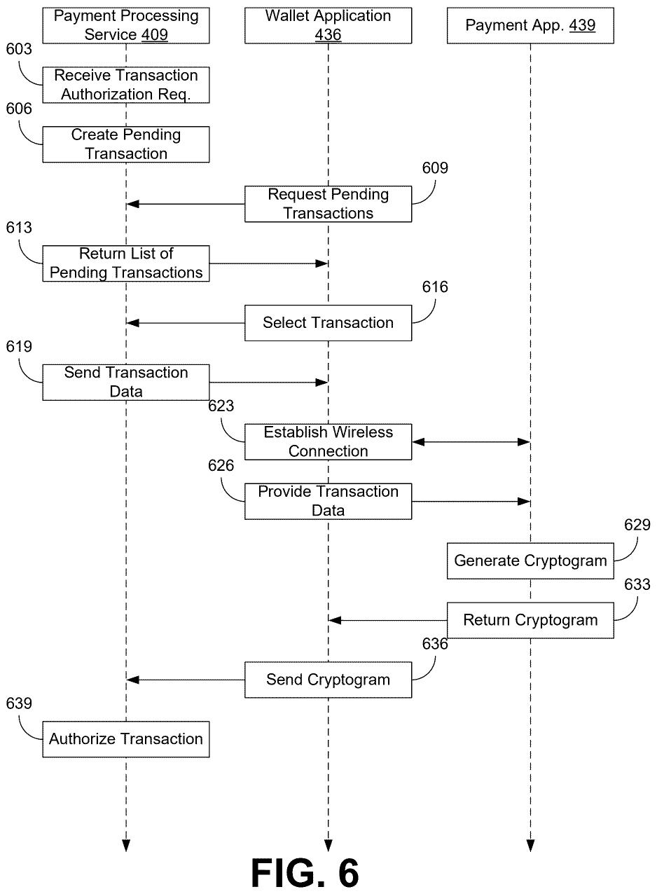

Referring next to FIG. 6, shown is a sequence diagram that provides one example of the operation of portions of the payment processing service 409, wallet application 436, and the payment application 439. The sequence diagram of FIG. 6 provides merely an example of the many different types of functional arrangements that can be employed to implement the operation of the depicted portions of the payment processing service 409, wallet application 436, and the payment application 439. As an alternative, the sequence diagram of FIG. 6 can be viewed as depicting an example of elements of a method implemented within the network environment 400.

Beginning with block 603, the payment processing service 409 can receive a transaction authorization request from a merchant. For example, a merchant's point-of-sale (PoS) system could obtain payment information from a user for a transaction. In a card-not-present (CNP) transaction, such as when a user makes a purchase with online (e.g., e-commerce) merchant, the merchant could obtain information such as the user's name, billing address, payment account identifier 423, payment account expiration date, and/or a card security code (CSC) or card verification value (CVV). This information could be included with a merchant identifier 426, amount 429, and/or transaction identifier 419. This transaction data could be included in a transaction authorization request sent to the payment processing service 409.

Accordingly, at block 606, the payment processing service 409 could then create a transaction record 416 and store the received information in the transaction record 416 for future reference. Moreover, the transaction record 416 could be updated to indicate that the transaction is a currently pending transaction to reflect that the transaction has not posted (e.g., because authorization is incomplete or because funds have not yet been transferred to the merchant).

Subsequently, at block 609, the wallet application 436 could send a request to the payment processing service 409 for a list of all currently pending transactions. The request could include a user identifier (e.g., username or email address) associated with a payment account identifier 423 of the user. This could occur, for example, if a user wanted to see a list of pending transactions that could be authorized using his or her payment card 200 in conjunction with his or her client device 100. Alternatively, the wallet application 436 could send a request for all recent transactions and could sort pending from posted transactions within the user interface 106 presented on the display 103 of the client device 100.

In response, at block 613, the payment processing service 409 could return a list of pending transactions. The list of pending transactions can include the transaction identifier 419 for each transaction record 416 associated with a transaction. For example, the payment processing service 409 could search for all transaction records 416 with a pending status that also have a payment account identifier 423 in the transaction record 416 that matches the payment account identifier 423 associated with the user identifier of the user. The payment processing service 409 could then send a list of matching transactions to the wallet application 436. Similarly, if all recent transactions were requested, the payment processing service 409 could search for all transaction records 416 for transactions that occurred after a given point in time where the payment account identifier 423 in the transaction record 416 that matches the payment account identifier 423 associated with the user identifier of the user.

Next, at block 616, the wallet application 436 can obtain a selection of a pending transaction from the user. For example, the wallet application could present a list of pending transactions within a user interface 106 shown on the display 103 of the client device. The user interface 106 could allow a user to view and select individual transactions to authorize using his or her payment card 200. Once a user has a selected a transaction, the transaction identifier 419 for the selected transaction could be returned to the payment processing service 409.

In response, at block 619, the payment processing service 409 could send transaction data related to the selected transaction to the wallet application 436. For example, the payment processing service 409 could retrieve the transaction data from a transaction record 416 with a matching transaction identifier 419. The transaction data sent to the wallet application 436 can include the merchant identifier 426 associated with the transaction, the amount 429 of the transaction, and the date/time of the transaction, as well as other information that might be desired for generating a cryptogram.

Next, at block 623, the wallet application 436 of the client device 100 can establish a wireless connection with the payment application 439 of a payment card 200. For example, the user could place his or her payment card 200 in proximity to the client reader 433 of the client device 100, allowing the client device 100 and payment card 200 to establish a wireless connection (e.g., a near-field communication (NFC) connection).

Then, at block 626, after the wireless connection has been established, the wallet application 436 can provide the transaction data sent at block 619 by the payment processing service 409 to the payment application 439.

Proceeding to block 629, the payment application 439 can generate a cryptogram to reflect an authorization, approval, or verification of the transaction in response to receiving the transaction data from the wallet application 436. The cryptogram can be generated using the cryptogram generating key 443 and potentially other data (e.g., an application transaction counter (ATC)). Various algorithms can be used, such as cryptogram generating algorithms specified by various versions of the EUROPAY-MASTERCARD-VISA (EMV) standard or other publicly available cryptogram generating algorithms. For example, the payment application 439 could generate an Authorization Request Cryptogram (ARQC) or a Transaction Certificate (TC).

Then, at block 633, the payment application 439 can return the cryptogram at block 519 to the wallet application 436 using the wireless connection established at block 511.

Next, at block 636, the wallet application can send the cryptogram generated by the payment application 439 at block 516 and provided at block 519 back to the payment processing service 409.

Subsequently, at block 639, the payment processing service 409 can authorize the transaction associated with the transaction authorization request. The authorization can be based at least in part on the cryptogram, as well as other factors. For example, the payment processing service 409 could determine that the cryptogram is a valid cryptogram. This could be used to verify that the user has the physical payment card 200 in his or her possession to use to authenticate the transaction that was made with the merchant, effectively allowing a CNP transaction (such as an ecommerce transaction) to be treated as a card-present transaction. In some implementations, the payment processing service 409 could generate an application response cryptogram (ARPC) and return it to the terminal of the merchant (e.g., via the acquirer of the merchant).

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts and sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e. g, storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

1. A system, comprising:
a computing device comprising a processor, a memory, and a reader; and
machine-readable instructions stored in the memory that, when executed by the processor, cause the computing device to at least:
receive, from a payment processing service, transaction data associated with a transaction;
establish a wireless connection with a payment card using the reader, wherein the reader is a smartphone, tablet, or mobile device;
provide the transaction data to the payment card;
receive a cryptogram for the transaction from the payment card, the cryptogram being generated by the payment card using a cryptogram generating key stored on the payment card; and
send the cryptogram for the transaction to the payment processing service.

2. The system of claim 1, wherein the machine-readable instructions further cause the computing device to at least:
show a prompt to select the transaction from a plurality of transactions; and
send a request for the transaction data to the payment processing service.

3. The system of claim 1, wherein the machine-readable instructions further cause the computing device to at least show a prompt to obtain authorization to provide the transaction data to the payment card prior to providing the transaction data to the payment card.

4. The system of claim 1, wherein the reader is a near-field communication (NFC) reader and the wireless connection is an NFC connection.

5. The system of claim 1, wherein the transaction data includes an amount of the transaction.

6. The system of claim 1, wherein the transaction data includes a merchant identifier for a merchant associated with the transaction.

7. The system of claim 1, wherein the transaction data includes a payment account identifier.

8. A method, comprising:
receiving, from a payment processing service, transaction data associated with a transaction;
establishing a wireless connection with a payment card using a reader, wherein the reader is a smartphone, tablet, or mobile device;
providing the transaction data to the payment card;
receiving a cryptogram for the transaction from the payment card, the cryptogram being generated by the payment card using a cryptogram generating key stored on the payment card; and
sending the cryptogram for the transaction to the payment processing service.

9. The method of claim 8, further comprising:
showing a prompt to select the transaction from a plurality of transactions; and
sending a request for the transaction data to the payment processing service.

10. The method of claim 8, further comprising showing a prompt to obtain authorization to provide the transaction data to the payment card prior to providing the transaction data to the payment card.

11. The method of claim 8, wherein the reader is a near-field communication (NFC) reader and the wireless connection is an NFC connection.

12. The method of claim 8, wherein the transaction data includes an amount of the transaction.

13. The method of claim 8, wherein the transaction data includes a merchant identifier for a merchant associated with the transaction.

14. The method of claim 8, wherein the transaction data includes a payment account identifier.

15. A non-transitory, computer-readable medium, comprising machine-readable instructions that, when executed by a processor of a computing device that comprises a reader, cause the computing device to at least:
receive, from a payment processing service, transaction data associated with a transaction;
establish a wireless connection with a payment card using the reader, wherein the reader is a smartphone, tablet, or mobile device;
provide the transaction data to the payment card;
receive a cryptogram for the transaction from the payment card, the cryptogram being generated by the payment card using a cryptogram generating key stored on the payment card; and
send the cryptogram for the transaction to the payment processing service.

16. The non-transitory, computer-readable medium of claim 15, wherein the machine-readable instructions further cause the computing device to at least:
show a prompt to select the transaction from a plurality of transactions; and
send a request for the transaction data to the payment processing service.

17. The non-transitory, computer-readable medium of claim 15, wherein the machine-readable instructions further cause the computing device to at least show a prompt to obtain authorization to provide the transaction data to the payment card prior to providing the transaction data to the payment card.

18. The non-transitory, computer-readable medium of claim 15, wherein the reader is a near-field communication (NFC) reader and the wireless connection is an NFC connection.

19. The non-transitory, computer-readable medium of claim 15, wherein the transaction data includes an amount of the transaction.

20. The non-transitory, computer-readable medium of claim 15, wherein the transaction data includes a payment account identifier.
